(19) United States
(12) Patent Application Publication
(10) Pub. No.: US 2013/0084214 A1
(43) Pub. Date: Apr. 4, 2013

(54) Ion-Selective Ion Concentration Meter

(71) Applicants: Frederick Quincy Johnson, Pleasanton, CA (US); Mark Bain, Mountain View, CA (US); Henry Roskos, Los Gatos, CA (US)

(72) Inventors: Frederick Quincy Johnson, Pleasanton, CA (US); Mark Bain, Mountain View, CA (US); Henry Roskos, Los Gatos, CA (US)

(21) Appl. No.: 13/629,116

(22) Filed: Sep. 27, 2012

Related U.S. Application Data
(60) Provisional application No. 61/541,928, filed on Sep. 30, 2011.

(51) Int. Cl. G01N 27/00; G01N 37/00

(52) U.S. Cl. 422/82.03; 73/61.43

(57) ABSTRACT

An ion concentration meter measures a concentration of an ion in a solution by exposing both an ISFET gate and a reference electrode within a filtered test area. In preferred embodiments, the test area filters preferred compounds from a solution being tested by occluding an opening to the test area with a species-selective membrane. Contemplated species-selective membranes include silicate membranes, chalcogenide membranes, lanthanum fluoride membranes, and valinomycin membranes.

This application claims priority to U.S. provisional application Ser. No. 61/541928 filed Sep. 30, 2011.

### FIELD OF THE INVENTION

The field of the invention is ion concentration meters.

### BACKGROUND

It is known to use ion-sensitive field effect transistors (ISFET) devices to measure the concentration of ions in a solution being tested. When the gate of an ISFET is exposed to a solution being tested, the current or the voltage difference across the source and drain of the ISFET can be used to identify the number of ions within the solution being tested, typically cations. An ISFET device, however, does not have the ability to differentiate between different types of ions, for example a hydrogen ion or a sodium ion. This makes it difficult to determine the number of hydrogen items in a solution being tested with both hydrogen ions and sodium ions.

U.S. Pat. No. 4,816,118 to Oyama teaches an ISFET device having an ion-selective membrane over the gate so that only selected ions from the solution being tested will provide a conductive path between the source and drain of the ISFET device. By providing an ion-selective membrane over only the gate area of the ISFET, however, Oyama's device will be inaccurate since the potential for the reference electrode will be set within the solution being tested while the gate will be exposed to only a filtered portion of the solution being tested. In addition, ion-selective membranes frequently allow more than one type of ion through the membrane, which could result in an adulterated test if the solution being tested happens to have both types of ions that can permeate through the membrane.

WO2009/137834 to Difoggio teaches an ISFET device that has a plurality of ion-selective sensors, which allows a user to test for a specific type of ion by detecting the concentration of ions that permeate through several different ion-selective membranes and cross-correlating their different responses to a common solution being tested. However, Difoggio may still introduce inaccuracies since the concentration of a specific ion is inferred from the cross-correlation instead of being directly measured.

This and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

Thus, there is still a need for improved methods of selecting ions measured by an ion concentration meter.

### SUMMARY OF THE INVENTION

The inventive subject matter provides apparatus, systems and methods in which an ion concentration meter measures a concentration of an ion in a solution by exposing both an ISFET gate and a reference electrode within a filtered test area.

In preferred embodiments, the test area filters preferred compounds from a solution being tested by occluding an opening to the test area with a species-selective membrane. As used herein, a “species-selective membrane” is a membrane which is permeable to only a subset of chemical species within a solution being tested. For example, a membrane could be placed around a test area such that only hydrogen ions or sodium ions could pass through, or a membrane that is only permeable towards lipids could be engaged, or a membrane that only allows negatively charged ions could occlude the test area. Contemplated species-selective membranes include silicate membranes, chalcogenide membranes, lanthanum fluoride membranes, and valinomycin membranes.

One should appreciate that an ion concentration meter of the current invention will increase the accuracy of an ISFET measurement by exposing both the gate(s) and the reference electrode(s) to a filtered solution being tested solution.

### BRIEF DESCRIPTION OF THE DRAWING

FIG. 1 is a schematic of an embodiment of the present invention.

FIG. 2 is a schematic of an alternative embodiment of the present invention.

FIG. 3 is a schematic of another alternative embodiment of the present invention.

FIG. 4 is a schematic of another alternative embodiment of the present invention.

### DETAILED DESCRIPTION

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

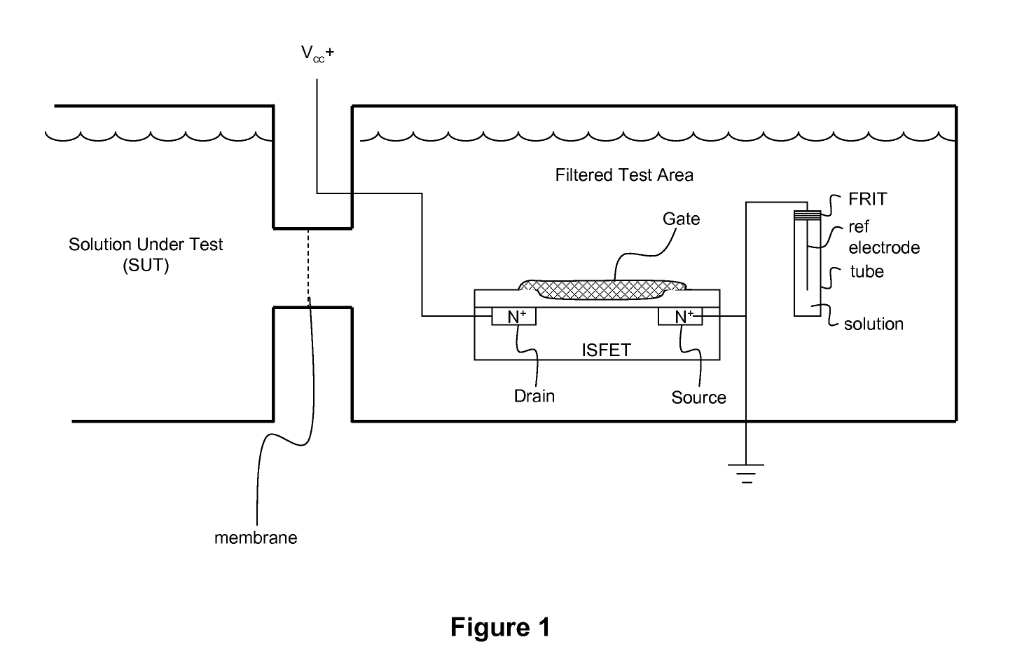

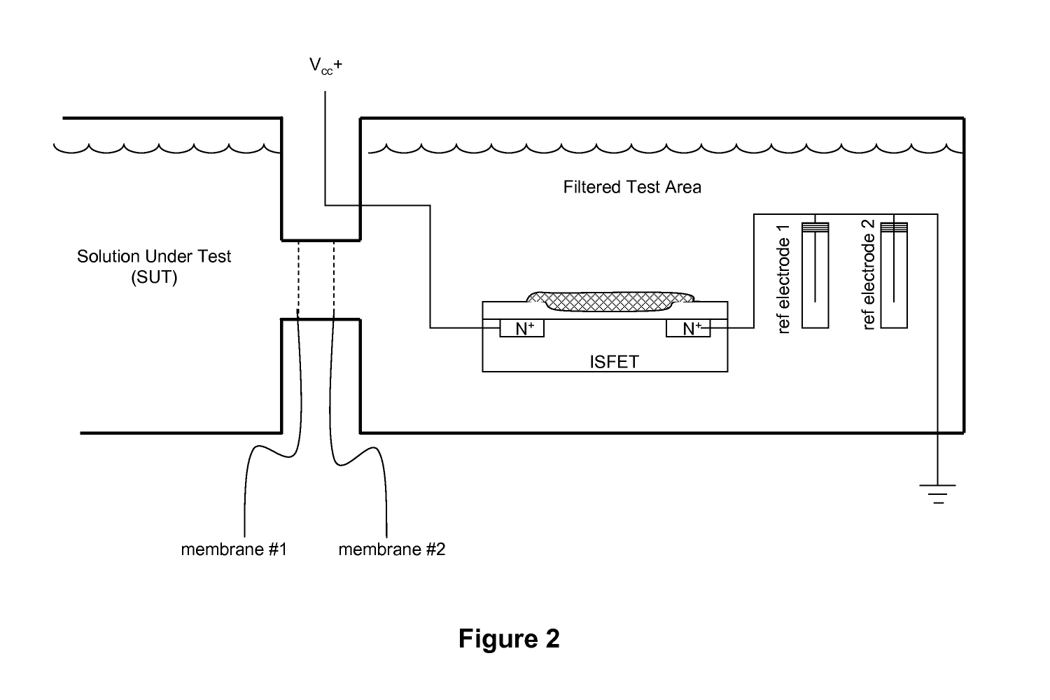

In FIGS. 1 and 2, a solution being tested is typically exposed to the test area through a fluid contact opening that is occluded by one or more chemical species-selective membranes. In one embodiment, each of the membranes occluding the opening is made from the same material to ensure that only specific chemicals flow from the solution being tested to the test area. In another embodiment, the membranes could be made from different materials, where each material filters a separate set of chemical species, narrowing the kind of chemical that can reach the test area. For example, a first membrane could be used that allows only oxide ions through such that both CO₂ and O₂ diffuse from the solution being tested, and a second membrane could be used to filter out carbon molecules such that only O2 molecules enter the test area. Since only the chemical species of interest are allowed to reach the gate, the concentration detected by the ISFET gate should correspond directly with the chemical species of interest that have been filtered by the membrane(s). As used herein, “fluid contact” means a channel through which a fluid or a gel can flow from one chamber to another. Two items that are in “fluid contact” with one another are situated such that a fluid that is in contact with one item can also be in contact with the other item simultaneously. One should also appreciate that in the following embodiments, the p+ and n+ material could be switched, in order to measure negative ions instead of positive ions.

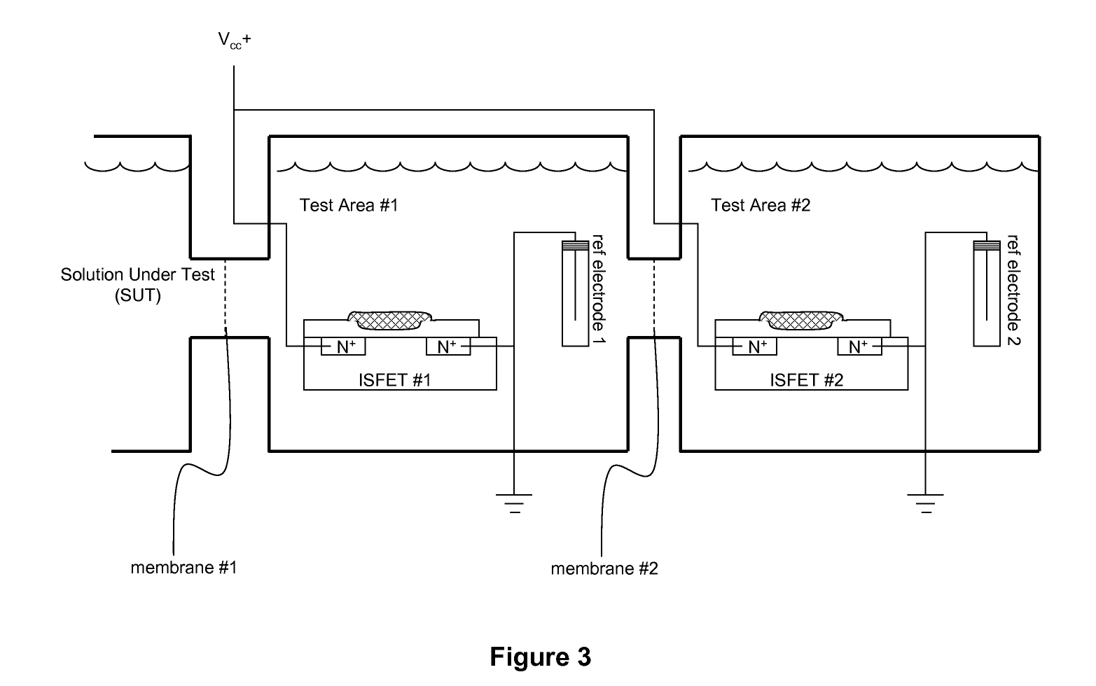

In FIG. 3, multiple ISFET gates and multiple test areas are positioned serially from one another to measure the concentration of a filtered solution being tested that's only been filtered by a single chemical-species membrane, and a filtered solution being tested that's been filtered by more than one chemical species-selective membrane. In this manner a first measurement could be made to measure the concentration of a chemical species and a second measurement could be made to measure the concentration of a subset of the chemical species. This is particularly useful for POC blood analysis, where a user might want to know the concentration of positive ions within a solution as well as a concentration of a particular type of positive ion.

Ion selection could be further improved by introducing a reactive fluid or gel within the test area that could react with a selected chemical species to break it apart into ions that would react with the ISFET gate. For example, a membrane could be configured to only allow water molecules into the test area, and sodium acetate could be introduced into the test area in order to break the water molecules into hydrogen cations and hydroxide anions. In another embodiment, a gel could be used which only reacts with HCO₃ to reduce the free CO₂ in the solution. Such an embodiment allows an indirect reading for both O₂ and CO₂/HCO₃ when the reading is compared with a second ion concentration meter without such a gel around the gate.

In an alternative embodiment, an environmental variable could be introduced to ionize molecules that diffuse into the test area, such as by using a polarographic cell. In an exemplary embodiment, the entire test area could be enclosed within a solid membrane, such that a user could “dip” the test area within a solution being tested to obtain a proper reading. The solid membrane could be formed into a cylindrical tube in order for it to be placed within a centrifuge machine, which may assist the chemical reaction if reactive fluids or gels have been introduced to the test area in order to break down the selected chemical.

Since both the surface of the ISFET gate and the frit of the reference electrode are in fluid contact with the test area, the driving force on the diffusing species is purely concentration related, and the device is able to avoid any electronic offset that would be found in a device where the reference electrode frit is exposed to an unfiltered solution being tested. In one embodiment, the FRIT above the reference electrode could be removed such that the metal (i.e. silver, gold) is in direct contact with the solution being tested. This achieves a “gain” effect since the voltage provided by the reference electrode would then be directly dependent upon the concentration of active ions instead of indirectly dependent upon the concentration, increasing control over the action of the gate and enhancing the signal.

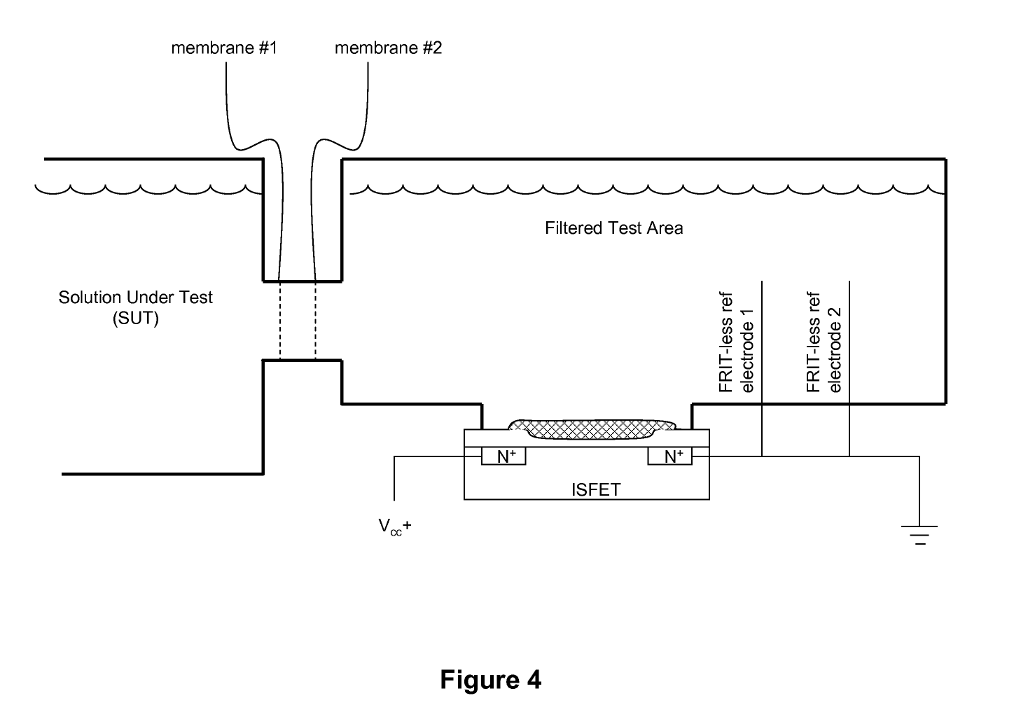

As shown in FIG. 2, multiple reference electrodes could be utilized which are biased relative to one another as well. The frit material and solution material in each of the two reference electrodes could vary in order to induce different voltage references. Use of pairs of reference electrodes made from metals or alloys of metals such as platinum, palladium, iron or gold, where each reference electrode is set at a slightly different voltage could allow a user to generate ions from atoms or molecules in the solution being tested to measure molecular concentration of such atoms or molecules in the solution. In such a solution, O₂ molecules would split into 2O⁻ molecules where the electrode is made from Pt, and HCO₃⁻ molecules would split into CO₂ and OH⁻ molecules where the electrode is made from Pd. Preferably such reference electrode pairs are FRIT-less to enhance the signal, as shown in FIG. 4.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. An ion meter that measures a concentration of an ion in a solution, comprising:
a container that defines a test area with an opening in fluid contact with the solution, wherein the opening is occluded by a chemical species-selective membrane;
an ISFET having a gate having a first surface that is fluidly coupled with the test area;
a first reference electrode having a second surface that is fluidly coupled with the test area; and
a processor that calculates the concentration based upon electronic activity across the ISFET.

2. The ion meter of claim 1, wherein the first reference electrode is disposed within a frit-filtering container that is fluidly coupled with the test area.

3. The ion meter of claim 1, wherein the first reference electrode comprises an inert metal.

4. The ion meter of claim 3, wherein the inert metal comprises platinum.

5. The ion meter of claim 1, further comprising a second reference electrode having a third surface that is fluidly coupled with the test area, wherein the second reference electrode is biased relative to the first reference electrode.

6. The ion meter of claim 3, further comprising a second reference electrode having a third surface that is fluidly coupled with the test area and wherein the second reference electrode comprises a second inert metal.

7. The ion meter of claim 6, wherein the second inert metal comprises platinum.

8. The ion meter of claim 1, further comprising a reactant gel disposed within the test area, wherein the reactant gel comprises a chemical that reacts to the solution to increase a concentration of the ion.

9. The ion meter of claim 1, further comprising a reactant gel disposed within the test area, wherein the reactant gel comprises a chemical that reacts to the solution to change a concentration of the ion.

10. The ion meter of claim 1, wherein the change in concentration of the ion is a decrease in the concentration of the ion.

11. The ion meter of claim 1, wherein the first reference electrode comprises a catalytic metal.

12. The ion meter of claim 11, wherein the catalytic metal comprises palladium, platinum or gold.

13. The ion meter of claim 1, wherein the first reference electrode has a catalytic effect with the solution.

14. The ion meter of claim 13, wherein the first reference electrode comprises iron and the solution comprises ammonia.

15. The ion meter of claim 13, wherein the solution comprises blood, urea, or nitrogen.
